(19) United States
(12) Patent Application Publication
(10) Pub. No.: US 2015/0125963 A1
(43) Pub. Date: May 7, 2015

(54) TECHNIQUES FOR ENSURING IDENTIFICATION AND CHAIN OF CUSTODY INFORMATION OF DRIED SAMPLES

(71) Applicant: Waters Technologies Corporation, Milford, MA (US)

(72) Inventor: Richard W. Andrews, Rehoboth, MA (US)

(21) Appl. No.: 14/406,291

(22) PCT Filed: Jun. 26, 2013
(86) PCT No.: PCT/US13/47809

§ 371 Date: Dec. 8, 2014

Related U.S. Application Data
(60) Provisional application No. 61/668,569, filed on Jul. 6, 2012.

(51) Int. Cl. B01L 3/00

(52) U.S. Cl. CPC B01L 3/545; B01L 3/5055; B01L 2300/022; B01L 2300/126; B01L 2300/0816
USPC 436/174; 422/552

(57) ABSTRACT

Techniques for use with dried sample portions include a device having sample areas, identification areas and detachable portions. Each sample area includes one of the dried sample portions of the sample. Each identification area includes information stored therein which identifies the sample from which the dried sample portions stored on the sample areas of the device are obtained. Each detachable portion includes one of the sample areas and includes one of the identification areas. Also described is a method for processing dried sample portions of a sample. A card is received that includes a plurality of detachable portions. Each detachable portion includes a sample area with a dried sample portion and an identification area including information that identifies the sample. A first detachable portion is detached to process a dried sample portion included in the first detachable portion.

### RELATED APPLICATION

This application claims priority to and the benefit of U.S. provisional application No. 61/668,569, filed Jul. 6, 2012, entitled TECHNIQUES FOR ENSURING IDENTIFICATION AND CHAIN OF CUSTODY INFORMATION OF DRIED SAMPLES, which is incorporated by reference herein.

### BACKGROUND

1. Technical Field

This application generally relates to sample identification and tracking

2. Description of Related Art

Different samples may be analyzed such as in a laboratory by a scientific instrument for any one or more different purposes. In connection with a blood sample, one technique utilizes dried blood spots included on a card. One existing technique includes placing multiple dried blood spots on the card which is sent to a laboratory. A portion of the dried blood spot sample on the card may be manually punched out, such as with a paper hole punch. The punched out card portion including the dried blood may be assayed directly by extraction, elution, or other form of chemical treatment suitable for the particular sample analysis performed in the laboratory. For example, the punched out portion of the card containing the dried blood spot sample may be placed in a test tube or other sample vial and mixed with a solvent or other chemical in preparation for subsequent analysis in the laboratory.

The card containing the dried blood spot samples may include a single set of identification information regarding the samples on the card. The identification information may be manually placed on the card and may be, for example, handwritten information at a single location on the card. When the dried blood sample is punched from the card, the punched sample which is analyzed in the laboratory is then physically separated from its single set of identifying information on the card.

Problems may arise due to physically separating the punched out sample portion analyzed in the laboratory from its identifying information as contained on the card. For example, in connection with the foregoing, errors regarding misidentification of the dried blood spot sample included on the punched out portions may result.

### SUMMARY OF THE INVENTION

In accordance with one aspect of the invention is a device for storing dried sample portions of a sample comprising: a plurality of sample areas, wherein each of said plurality of sample areas include one of the dried sample portions of the sample; a plurality of identification areas, wherein each of said plurality of identification areas includes information stored therein which identifies the sample from which the dried sample portions stored on the plurality of sample areas of the device are obtained; and a plurality of detachable portions, wherein each of said plurality of detachable portions includes one of the plurality of sample areas and includes one of the plurality of identification areas. Each of the plurality of identification areas may include a radio-frequency identification tag including the information stored thereon. The information stored in each of the plurality of identification areas may be encoded as any of machine-readable information and human-readable information in the identification area. Each of the plurality of identification areas may include one or more bar codes encoding the information. The device may be made of any of paper and a cellulose-based material. The device may be a card. Each of the plurality of sample areas may be chemically treated based on any of the particular dried sample portion stored on said each sample area and analysis performed on the dried sample portion stored on said each sample area. The information stored in each of the plurality of identification areas may include one or more information fields including a first field with a sample identifier, the sample identifier uniquely identifying the sample from which the dried sample portions included in the plurality of sample areas are obtained. At least a first of the one or more information fields may be used to access additional information about the sample in a database. The additional information may include chain of custody information stored in the database. The chain of custody information may include a point of origin for the sample and identifies tracking information about the sample as dried sample portions of the sample stored on the plurality of sample areas of the plurality of detachable portions are processed. The tracking information may include date and/or time information regarding processing performed on dried sample portions stored on the plurality of areas of the plurality of detachable portions, may identify one or more individuals that performed processing on dried sample portions stored on the plurality of sample areas of the plurality of detachable portions, and may identify one or more analytical instruments used in connection with performing processing on dried sample portions stored on the plurality of sample areas of the plurality of detachable portions. The one or more information fields stored in each of the plurality of identification areas of each of the plurality of detachable portions may include a second field uniquely identifying said each detachable portion from others of said detachable portions of the device. A plurality of devices may include dried sample portions of the sample. The device may be a first of the plurality of devices, and each of the plurality of identification areas of the first device may include a third field uniquely identifying said first device from others of the plurality of devices. The sample may be any of blood, urine, and water. The radio frequency identification tag of each of the plurality of identification areas may transmit a unique serial number uniquely identifying the radio frequency identification tag in response to an interrogation signal. The unique serial number may be associated in a database with other information about the sample. The device may include a device identification area including the information stored therein which identifies the sample from which the dried sample portions stored on the plurality of sample areas of the device are obtained.

In accordance with another aspect of the invention is a method for processing dried sample portions of a sample comprising: receiving a card including a plurality of detachable portions, wherein each of said plurality of detachable portions includes one of a plurality of sample areas and includes one of a plurality of identification areas, wherein each of said plurality of sample areas includes one of the dried sample portions of the sample and wherein each of said plurality of identification areas includes information stored therein which identifies the sample from which the dried sample portions stored on the plurality of sample areas of the card are obtained; and detaching a first of the plurality of detachable portions to process a first of the dried sample portions included in said first detachable portion. The method may include recording chain of custody information for said first detachable portion when the first dried sample portion is processed. The card may include a card identification area including the information stored therein which identifies the sample from which the dried sample portions stored on the plurality of sample areas of the device are obtained. The card identification area and each of the plurality of identification areas may include a radio frequency identification tag including the information stored thereon.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment of a device including detachable portions with sample areas and identification areas in accordance with techniques herein;

FIG. 2 is an example of components as may be used in a system in an embodiment in accordance with techniques herein;

FIG. 3 is an example illustrating how a dried sample portion of a detachable portion may be assayed in an embodiment in accordance with techniques herein; and

FIG. 4 is an example representation of information stored in a database in one embodiment in accordance with techniques herein; and

FIG. 5 is a flowchart of processing steps as may be performed in an embodiment in accordance with techniques herein.

### DETAILED DESCRIPTION OF EMBODIMENT(S)

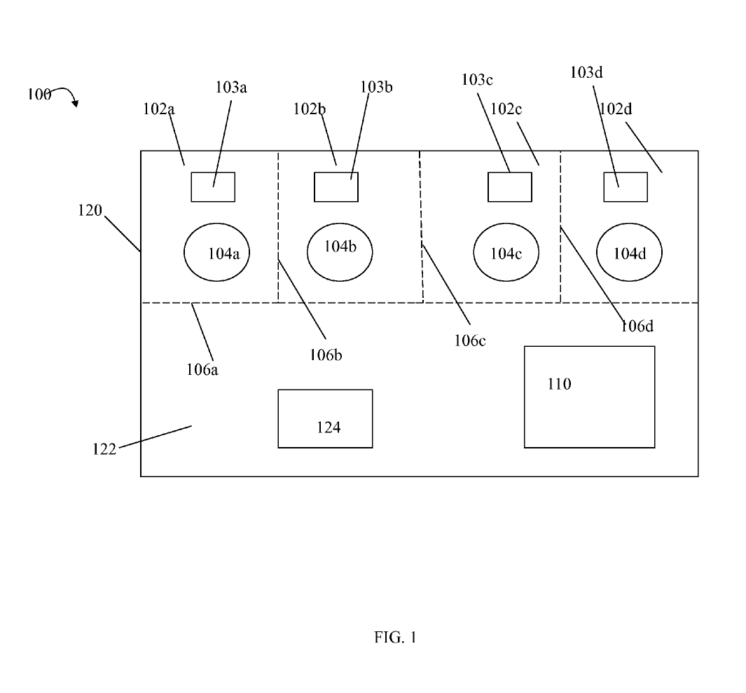

Referring to FIG. 1, shown is an example representation of a card, or more generally a sample holding device, including a plurality of sample portions in accordance with techniques herein. The example 100 includes a card 120 with a plurality of detachable portions 102a-102d, a plurality of sample areas 104a-104d, a plurality of identification areas 103a-103d, a card or device identification area 124 and other information area 110. Detachable portion 102a may include one of the plurality of sample areas 104a and one of the plurality of identification areas 103a. In a similar manner, each of the remaining detachable portions 102b-102d may include, respectively, a different one of the plurality of sample areas 104b-104d and a different one of the identification areas 103b-103d. Elements 106a-106d denote perforated lines forming the detachable portions 102a-102d.

Each of the detachable portions 102a-102d may be configured, such as using perforated lines 106a-106d, to be detached from the card 120 at the laboratory for processing. In the illustrated embodiment, the detachable portions 102a-102d are formed from perforated lines 106a-106d to facilitate detaching or separating each such portion 102a-102d from the remainder of the card. For example, detachable portion 102a may be separated from the remainder of the card along the perforated lines 106a-106b when processing a sample portion included in sample area 104a in the laboratory. In a similar manner, each of the other portions 102b-102d may be detached from the card 120. When any one of the detachable portions 102a-102d is separated from the remainder of the card 120 based on the perforated lines 106a-106d, each such detachable portion includes one of the sample areas 104a-104d and one of the identification areas 103a-103d.

Each of the sample areas 104a-104b may include a dried or residual sample, such as a dried blood sample. Although description herein may refer to a particular type of sample, such as a dried blood spot sample, included in the sample areas 104a-104d, more generally, sample areas 104a-104d may include any dried or residual sample which is analyzed in the laboratory. For example, sample areas 104a-104d may include dried urine samples, dried water samples, and the like. In connection with dried water samples, for example, the water may be placed on each of sample areas and allowed to dry thereby leaving a residual that may include pollutants or contaminants, such as metals, as may be detected in connection with subsequent laboratory sample analysis processing. The areas 104a-104d may be sample wells or indentations for the blood or other sample portion which is placed on the card and allowed to subsequently dry leaving a residual sample for analysis.

Each of the identification areas 103a-103d may include information identifying the sample from which the dried or residual sample portions in areas 104a-104d are obtained. In one embodiment, all areas 104a-104d may include sample portions from a same sample such as, for example, blood or urine obtained from a same patient or animal, water sample portion obtained from a same water sample source location, and the like. In one embodiment, each of the identification areas 103a-103d may include an RFID (Radio frequency identification) tag or label. The RFID tag in each identification area 103a-103d may include the foregoing information used in identifying the sample from which the dried or residual sample portions in areas 104a-104d are obtained. The RFID tag in each identification area 103a-103d may be encoded with or may store information such as the information described above identifying the sample. As known in the art, RFID tags may include, for example, a integrated circuit for storing and processing information, modulating and demodulating a radio frequency (RF) signal, and other specialized functions. RFID tags may also include an antenna for receiving and transmitting RF signals. Generally, the RFID tags may be any commercially available readable and/or writeable RFID tag such as, for example, the UPM TRAP tag available from UPM Global (www.upmrfid.com), as may be used in an embodiment in connection with techniques herein. The RFID tag in each identification area 103a-103d may be located on a surface of the card 120 or otherwise embedded between surfaces of the card 120. In a similar manner, identification area 124 may also include an RFID tag associated with entire card or device 120. In other words, identification area 124 may include the same or similar information as described herein for each area 103a-103d but area 124 remains with the card and is not included in a detachable portion.

It should be noted that although identification areas 103a-103d and 124 are described in exemplary embodiments herein using RFID tags, it will be appreciated by those of ordinary skill in the art that other suitable technologies and techniques may also be utilized in an embodiment in accordance with techniques herein. For example, embodiments may use other machine-readable and/or human readable information to represent or encode the one or more fields of identifying information. For example, the one or more fields of identifying information may be represented or encoded as one or more bar codes, as magnetically readable information, as machine and/or human readable information recognized via OCR (optical character recognition), and the like. Depending on the technology, such information may be appropriately included in areas 103a-103d. For example, bar codes may be imprinted or encoded on a surface of the card in each area 103a-103d. It should be noted that the particular technology and technique selected may vary with embodiment and the advantages provided by each. For example, an embodiment may utilize RFID tags rather than bar codes since RFID tags do not require line of sight between the RFID tag and a reader or interrogator module as described elsewhere herein in more detail.

Information stored on each of the RFID tags of 103a-103d, and also identification area 124, may include a same set of one or more fields of identifying information used to identify the sample from which the sample portions of 104a-104d are obtained. In this manner, the same set of one or more fields may be used to determine associated detachable portions and the card from which the detachable portions are separated. For example, each RFID tag of 103a-103d and 124 may include a first field that is a sample identifier used to uniquely identify the sample from which sample portions in 104a-104d are obtained. The one or more fields stored on each RFID tag of 103a-103d and 124 may also include other fields of identifying information such as, for example, a sample batch or lot number, a study number, and/or information identifying a point of origin of the sample portions contained in 104a-104d (e.g., a geographical or physical location for example, such as a university if the sample is obtained in connection with a study performed by the university). An embodiment may encode or represent the foregoing one or more fields of identifying information in any suitable manner. For example, an embodiment may encode multiple fields of information as a single numeric or alphanumeric or alphabetic identifier. Alternatively, an embodiment may use multiple such identifiers to encode or represent the desired identifying information (e.g., one or more fields) related to the sample.

The foregoing one or more fields of identifying information stored on each RFID tag (e.g., identifying the sample from which the sample portions of 104a-104d are obtained) may be used in connection with a database which stores other corresponding information for the sample, card, and the like. For example, the database may associate, store and track chain of custody information for the one or more fields of identifying information. The chain of custody information may identify/track the chain of custody for the sample and card 120 containing portions of the sample in areas 104a-104d. The chain of custody information may, for example, identify the point of origin (e.g., physical location or point of origin) of the sample, track the date/time, individuals, analytical instruments and tests performed on each sample portion of the card 120, and the like.

As known in the art, chain of custody is used in most chemical sampling situations to maintain the integrity of the sample by providing documentation of the control, transfer, and analysis of samples. For example, with respect to a sample used in connection with techniques herein, chain of custody information as may be recorded in the database and associated with the one or more fields of identifying sample information may identify and track the sample from its point or origin, identify information (e.g., date, time, operator, location) in connection with storing sample portions on the card such as illustrated in FIG. 1, and identify information (e.g., date, time, operator, location, analytical instrument and chemicals used) in connection with processing each sample portion in areas 104a-104b, and the like. To further illustrate, when a dried sample portion in one of the areas 104a-104d is processed at an instrument in the laboratory, information may be recorded regarding the processing performed, the operator/individual performing the processing, the instrument used to perform the processing, the location of the processing performed, information regarding the chemicals used in the analysis processing, and the like. The information recorded may be entered and recorded manually and/or automatically. For example, the operator may be required to provide information regarding a valid operator id for processing at an instrument to commence. The operator id may be, for example, manually entered by a user through a keyboard or other data entry device, entered automatically such as by a bar code reader that reads a badge with the operator id encoded as a bar code, and the like. When the operator id is obtained in connection with commencing processing at the instrument, instrument information may be also be obtained. The instrument information may include, for example, an instrument identifier uniquely identifying the processing instrument. The foregoing information regarding the details of processing performed at a point on the sample portion (included on one of the detachable portions 102a-102d) may be recorded in the database as part of chain of custody information associated with the sample from which the sample portion is obtained.

The card 120 may also include other data, information, and the like, in the remaining portion 122 of the card 120. For example, the card 120 may also include area 110 identifying any chemical preparation or treatment of the sample areas 104a-104d of the card 120. For example, area 110 may indicate, such as in human readable printed form, additives or chemical treatment of the sample areas 104a-104d to retain components of the dried samples in such sample areas, to affect of adjust the pH of such sample areas, and the like. The chemical treatment of the card may vary with the sample. The card 120 may be made from any suitable material known in the art. For example, the card may be a paper or cellulose-based product and may be optionally chemically treated. As noted above, the areas which are chemically treated may be areas 104a-104d where sample portions are located on the card. In area 110, the card itself may include information such as supplied by the card manufacturer as to the chemistry applied to areas 104a-104d of the cards. For example, the card 120 may be manufactured by Whatman International Ltd. An embodiment in accordance with techniques herein may modify an existing card, such as manufactured by Whatman International Ltd., which may not be configured to include the detachable portions 102a-102d and which may not include identification areas 103a-103d. Such a card may be modified to include such perforated lines 106a-106d and identification areas 103a-103d and 124 (e.g., by placing an RFID tag on the card surface or embedded within the card in each area 103a-103d).

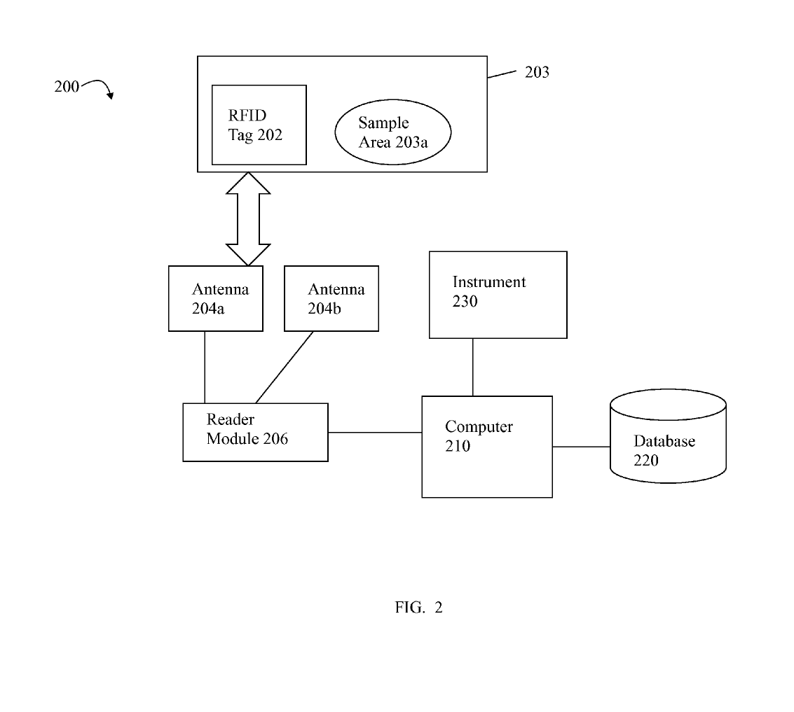

Referring to FIG. 2, shown is an example 200 of components that may be included in an embodiment of a system in accordance with techniques herein. The components of FIG. 2 may be included in a laboratory and used in connection with other techniques described herein. The example 200 includes a detachable portion 203 (e.g., such as one of 102a-102d of FIG. 1) including an RFID tag 202 (e.g., such as may be included in one of 103a-103d of FIG. 1) and a sample area 203 (e.g. such as one of the areas 104a-104d of FIG. 1), a computer 210, a database 220, an RFID tag reader or interrogation module 206, one or more antenna 204a-204b, and an instrument 230. Instrument 230 may be, for example, an analytical or other laboratory processing instrument system such as an LC (liquid chromatography) system.

As described elsewhere herein, RFID tag 202 may be affixed to a surface of the card or embedded within the card in each of the identification areas 103a-103d. The RFID tag 202 may be used in tracking and identifying the location of a detachable card portion 203 including the RFID tag 202. In operation, an RFID tag reader module 206 may interrogate one or more of the antenna elements regarding the location of a particular detachable portion of a card identified by its RFID tag 202. The module 206 may transmit an interrogation signal to one or more of the antennae 204a-204b. An antenna, such as 204a, may transmit a signal to a RFID tag 202. The RFID tag 202 receives this signal and may transmit back a return signal to 204a which includes the one or more fields of identifying information stored on the RFID tag 202. The module 206 may obtain (read) this identifying information and other information through this technique. The computer 210 may communicate with the module 206 to send and/or receive data which may be stored in the database 220. As described elsewhere herein, the identifying information stored in the RFID tag 202 may be used to store and obtain additional associated information such as, for example, chain of custody information associated with a sample (and sample portion of 203a) denoted by the identifying information as transmitted from the RFID tag 202. Through suitable techniques known in the art such as triangulation methods, a location of the RFID tag 202 may be determined at any desired point in time such as, for example, in connection with processing a sample portion in area 203a of detachable portion 203 including RFID tag 202. Such location information may be stored as part of the chain of custody information along with date/time information as to when the location information is recorded in the database. The instrument 230 may be used in connection with processing the sample portion 203a. The instrument 230 may communicate with a computer 210 in connection with controlling such processing and communicating any processing results as may be stored in a database 220.

In a manner similar to that as described above for each RFID tag 202 included in a detachable portion 102a-102d of a card, an RFID tag included in area 124 may also be utilized to obtain and store information.

With reference back to FIG. 1, each of the sample portions in areas 104a-104d of detachable portions 102a-102d may be processed. For example, a dried blood spot in 104a of 102a may be assayed by placing the detachable portion 102a in a device or apparatus, such as a flow-through clamp, through which suitable solvents may be pumped to extract or elute desired analytes.

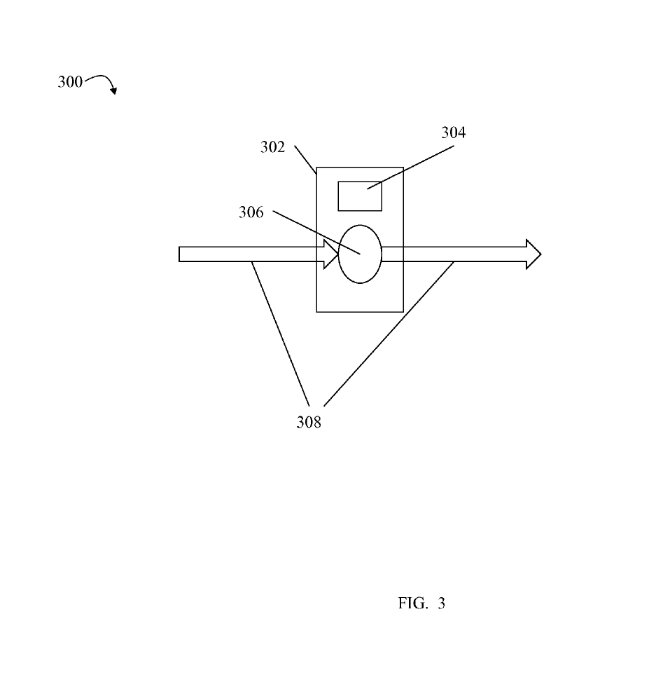

Referring to FIG. 3, shown is an example 300 of an apparatus that may be configured to hold a detachable portion of the card in an embodiment in connection with techniques herein. Element 304 may be the detachable portion including an RFID tag 304 and a sample area 306 including a sample portion such as dried blood. The apparatus may be configured to hold the detachable portion 304 in a stream or flow of suitable solvent 308. The apparatus may secure the detachable portion 304, such as using one or more clamps (not illustrated) at the top and bottom of the detachable portion 304. A flow or stream of solvent 308 such as in a tubing may pass through area 306 to extract or elute the desired analytes from the sample portion of 306.

In connection with the foregoing exemplary embodiments, a single sample may be associated with its sample portions on only a single card in accordance with techniques herein. However, it will be appreciated by those skilled in the art the techniques herein may be utilized in connection with a single sample having sample portions on more than one card. In such instances where a single sample has sample portions stored on multiple cards, the identifying information stored on each such card may identify the single sample and may also include other information, such as a card identifier, uniquely identifying and distinguishing amongst each of the multiple cards associated with the single sample. In this manner, chain of custody and other information as may be stored in the database may also be associated with each card corresponding to the single sample. The card identifier may be stored in the identification areas 103a-103d as well as the area 124 of the card. Alternatively, the card identifier may be stored in area 104 but not any of 103a-103d.

As another variation to that as described above such as in connection with FIG. 1, each identification area 103a-103d included in a different one of the detachable portions 102a-102d may also include a detachable portion identifier uniquely identifying and distinguishing amongst each of the detachable portions of a single card. For example, each RFID tag in each of 103a-103d may include such an identifier uniquely associated with and identifying the RFID tag and the detachable portion including the RFID tag. In this manner, chain of custody and other information as may be stored in the database may also be associated with each detachable portion of a card. In such an embodiment, the information of 124 of the card may include a list or other indicator of the detachable portion identifiers of the card.

In one embodiment using readable RFID tags in 103a-103d, each RFID tag may have a different unique serial number that is transmitted in response to a query from a reading device or module (e.g. element 206 of FIG. 2). In such an embodiment, the RFID tag's transmitted serial number may be associated with the detachable portion including the RFID tag. In turn, the detachable portion may be associated with a particular sample portion and sample from which the sample portion is obtained. The serial number may be used as an index into a database containing other associated information as described elsewhere herein. For example, a card may include 4 detachable portions each such detachable portion having a different RFID tag with a different serial number. The database may associate each such serial number with the same sample and same card. The database may also associate each serial number with a particular one of the detachable portions of the card thereby also allowing information, such as chain of custody information, to be associated with each detachable portion as well as the card including the detachable portion and also the sample from which the sample portion stored on the detachable portion is obtained.

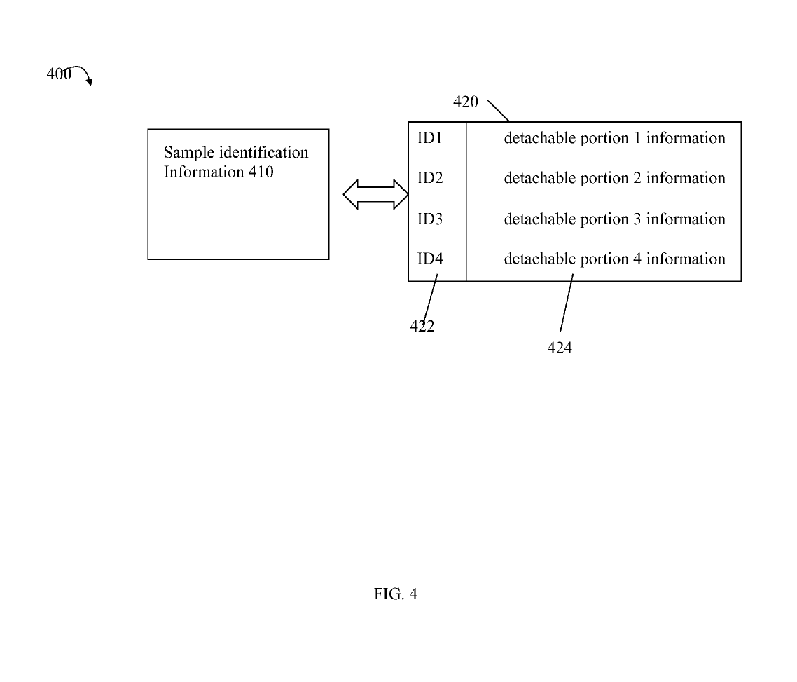

To further illustrate the foregoing latter example using RFID tags with unique serial numbers, reference is made to FIG. 4 in the example 400. The database may include sample identification information 410 which may include one or more fields identifying the sample such as a sample identifier, point of origin, and the like. The sample described by 410 may have portions thereof stored on a card as described above with 4 detachable portions each including an RFID tag that transmits a different serial number or identifier when interrogated. The database may include a table 420 associated with the sample identification information 410. Column 422 of table 420 may represent the four IDs or serial numbers—denoted ID1, ID2 ID3 and ID4—transmitted by the RFID tags of the 4 detachable portions of the card. Additional information may be associated with each detachable portion as denoted by 424. Using such associations, an embodiment may interrogate an RFID tag that transmits its unique serial number or ID. For example, ID1 may be transmitted by an RFID tag included in detachable portion 1. ID1 may be used as an index into the database to obtain and/or store associated detachable portion 1 information. Furthermore, information about the sample having a sample portion stored on detachable portion 1 with ID1 may be obtained through information 410 associated with table 420 (and each of the IDs 1-4 in 422). Thus, information may be stored in the database in 410 for the entire sample which may be associated with multiple detachable portions having information in 420 where such detachable portions include portions of the sample described by 410. Additionally, information specific to each detachable portion may also be stored as illustrated by a single row of the table 420.

With reference to FIG. 4, it should be noted that the RFID tag or other means for storing information included in device identification area 124 may also include a serial number such that each RFID tag included in any of 103a-103d and 124 has a unique serial number or ID. In this case, the unique ID for the RFID tag of 124 may also be stored in the database and associated with sample identification information 410. The database may store information to denote the unique ID (e.g. ID5) of the RFID tag associated with area 124 rather than one of the detachable portions. Although not illustrated in FIG. 4, table 420 may include an additional row having ID5 in column 422 associated with card or device information in 424.

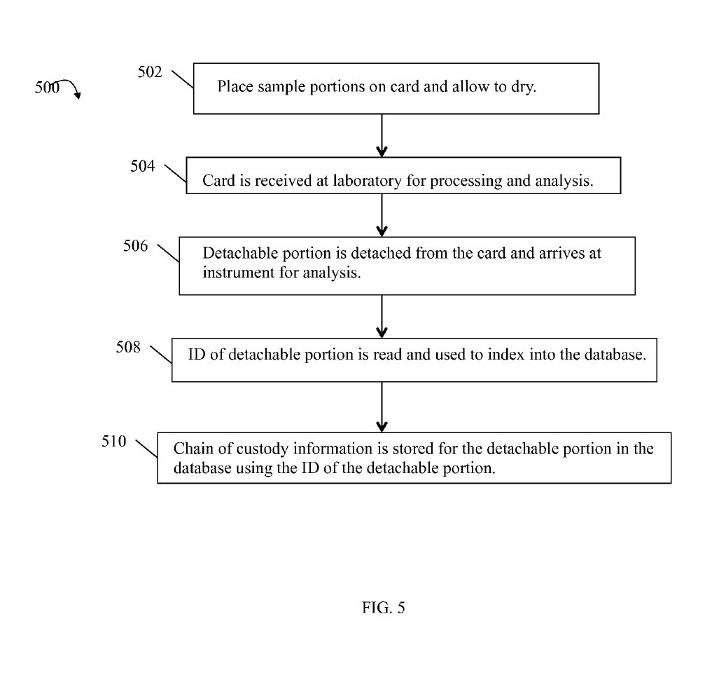

Referring to FIG. 5, shown is an example of processing as may be performed in an embodiment in accordance with techniques herein using the card such as described above. The flowchart 500 includes step 502 where sample portions, such as blood sample portions, may be placed on sample areas of the card and allowed to dry. At step 504, the card may then be sent to a laboratory for processing and analysis. At step 506, once at the laboratory, one of the detachable portions may be detached from the card. The detachable portion arrives at an instrument in the laboratory for analysis or other processing. At step 508, the ID or identifier of the detachable portion is read and may be used as an index into the database. The ID may be uniquely associated with a particular detachable portion of the card so that each detachable portion has its own such ID. In one embodiment as described herein, the ID may be a unique serial number transmitted by an interrogated RFID tag. In another embodiment, the foregoing ID may be encoded as a bar code that is read such as using a suitable bar code reader. In a similar manner and more generally, the foregoing ID (uniquely identifying the detachable portion) may be encoded or stored in the identification area of the detachable portion and obtained (e.g., read) in other appropriate ways dependent on the manner of encoding and storage. At step 510, chain of custody information may be obtained in connection with the analysis or processing performed by the instrument mentioned in connection with step 506. Such chain of custody information may be stored in the database for the detachable portion using the ID as described above.

It should be noted that, as described herein, each detachable portion may not have a unique identifier to distinguish between detachable portions. Rather, each detachable portion of a card may have an identification area including a same set of one or more fields of identifying information used to identify the sample from which the sample portions of the card are obtained. In such an embodiment, the one or more fields of identifying information encoded as one or more identifiers may be used as an index into the database to store and retrieve information at the level of granularity about the entire card and sample. With reference back to FIG. 1, the foregoing same set of one or more fields of identifying information may be stored in each detachable portion's identification area 103a-103d as well as the identification area 124 of the card. As described herein such as in connection with RFID tags stored in areas 103a-103d and 124, the common or same set of such information may be used to identify the card and each detachable portion thereof in the laboratory since the cards and its detachable portions include the same set of information.

The techniques herein may be used in connection with any one or more different purposes with any suitable sample. For example, the techniques herein may be used in connection with blood samples for animal studies, neo-natal and pediatric clinical blood samples, blood or other samples for drug or pharmaceutical development purposes, and the like.

It should be noted that the particulars of the example embodiments described above, such as number of detachable portions, number of sample areas on a card, number of identification areas on a card, shape of a card or area, and the like, should not be construed as a limitation of the techniques herein. Rather, as will be appreciated by those skilled in the art, techniques herein may be used with any suitable number of detachable portions, sample and identification areas, shapes, and the like.

As will be appreciated by those of ordinary skill in the art, the use of the card, or more generally the sample holding or storage device, for holding the dried blood or other samples is attractive by advantages such as decreased costs associated with storage and transportation of such samples. Another advantage is that the foregoing techniques provides for analysis of samples where the quantity of such samples may be limited. The techniques herein provide a benefit of maintaining identifying information about each sample portion in each detachable portion as each such sample portion is processed in the laboratory thereby reducing any possible error of sample misidentification. The identifying information may also be used to associate, store and maintain other information (e.g., chain of custody information) associated with the sample, card containing the sample portions, and/or detachable card portions.

It should also be noted that an ancillary benefit of the technique herein is that cross contamination and biohazard remediation may be more easily managed since the sample does not have to be manually punched by an analyst as in connection with some existing techniques.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A device for storing dried sample portions of a sample comprising:
a plurality of sample areas, wherein each of said plurality of sample areas include one of the dried sample portions of the sample;
a plurality of identification areas, wherein each of said plurality of identification areas includes information stored therein which identifies the sample from which the dried sample portions stored on the plurality of sample areas of the device are obtained; and
a plurality of detachable portions, wherein each of said plurality of detachable portions includes one of the plurality of sample areas and includes one of the plurality of identification areas.

2. The device of claim 1, wherein each of said plurality of identification areas includes a radio-frequency identification tag including the information stored thereon.

3. The device of claim 1 wherein the information stored in each of the plurality of identification areas is encoded as any of machine-readable information and human-readable information in said each identification area.

4. The device of claim 3, wherein each of the plurality of identification areas includes one or more bar codes encoding the information.

5. The device of claim 1, wherein the device is made of paper.

6. The device of claim 1, wherein the device is made of a cellulose-based material.

7. The device of claim 1, wherein the device is a card.

8. The device of claim 1, wherein each of the plurality of sample areas is chemically treated based on any of the particular dried sample portion stored on said each sample area and analysis performed on the dried sample portion stored on said each sample area.

9. The device of claim 1, wherein the information stored in each of the plurality of identification areas includes one or more information fields including a first field with a sample identifier, the sample identifier uniquely identifying the sample from which the dried sample portions included in the plurality of sample areas are obtained.

10. The device of claim 9, wherein at least a first of the one or more information fields is used to access additional information about the sample in a database.

11. The device of claim 10, wherein the additional information includes chain of custody information stored in the database.

12. The device of claim 11, wherein the chain of custody information includes a point of origin for the sample and identifies tracking information about the sample as dried sample portions of the sample stored on the plurality of sample areas of the plurality of detachable portions are processed.

13. The device of claim 12, wherein the tracking information includes date and/or time information regarding processing performed on dried sample portions stored on the plurality of areas of the plurality of detachable portions, identifies one or more individuals that performed processing on dried sample portions stored on the plurality of sample areas of the plurality of detachable portions, and identifies one or more analytical instruments used in connection with performing processing on dried sample portions stored on the plurality of sample areas of the plurality of detachable portions.

14. The device of claim 9, wherein the one or more information fields stored in each of the plurality of identification areas of each of the plurality of detachable portions includes a second field uniquely identifying said each detachable portion from others of said detachable portions of the device.

15. The device of claim 9, wherein a plurality of devices include dried sample portions of the sample, the device being a first of the plurality of devices, and wherein each of the plurality of identification areas of the first device includes a third field uniquely identifying said first device from others of said plurality of devices.

16. The device of claim 1, wherein the sample is any of blood, urine, and water.

17. The device of claim 2, wherein the radio frequency identification tag of each of the plurality of identification areas transmits a unique serial number uniquely identifying the radio frequency identification tag in response to an interrogation signal.

18. The device of claim 17, wherein the unique serial number is associated in a database with other information about the sample.

19. The device of claim 1, further comprising a device identification area including the information stored therein which identifies the sample from which the dried sample portions stored on the plurality of sample areas of the device are obtained.

20. A method for processing dried sample portions of a sample comprising:
receiving a card including a plurality of detachable portions, wherein each of said plurality of detachable portions includes one of a plurality of sample areas and includes one of a plurality of identification areas, wherein each of said plurality of sample areas includes one of the dried sample portions of the sample and wherein each of said plurality of identification areas includes information stored therein which identifies the sample from which the dried sample portions stored on the plurality of sample areas of the card are obtained; and
detaching a first of the plurality of detachable portions to process a first of the dried sample portions included in said first detachable portion.

21. The method of claim 20, further comprising:
recording chain of custody information for said first detachable portion when the first dried sample portion is processed.

22. The method of claim 20, wherein the card includes a card identification area including the information stored therein which identifies the sample from which the dried sample portions stored on the plurality of sample areas of the device are obtained.

23. The method of claim 22, wherein the card identification area and each of the plurality of identification areas includes a radio frequency identification tag including the information stored thereon.
